(19) United States
(12) Patent Application Publication
(10) Pub. No.: US 2020/0086364 A1
(43) Pub. Date: Mar. 19, 2020

(54) LANDFILL WELL HEAD COVER STABILIZATION MOUNT

(71) Applicant: Q.E.D. Environmental Systems, Inc., Dexter, MI (US)

(72) Inventors: Bryan D. SPICER, Monroe, MI (US); Brett M. CROUSE, Fenton, MI (US)

(21) Appl. No.: 16/526,541

(22) Filed: Jul. 30, 2019

Related U.S. Application Data
(60) Provisional application No. 62/731,556, filed on Sep. 14, 2018.

(51) Int. Cl. B09B 1/00; E21B 33/03

(52) U.S. Cl. CPC B09B 1/004; B09B 1/006; E21B 33/03

(57) ABSTRACT

A well head cover is disclosed for mounting on a landfill gas discharge pipe. The well head cover includes a polymer molded body, with the body having a neck with an outlet orifice surface sized to accommodate the landfill gas discharge pipe extending through the outlet orifice surface. A stabilizer is disposed within the body that stabilizes the polymer molded body to the landfill gas discharge pipe, and assists in maintaining the landfill gas discharge pipe in a vertically upright orientation.

### CROSS-REFERENCE TO RELATED APPLICATIONS

This application claims the benefit of U.S. Provisional Application No. 62/731,556, filed on Sep. 14, 2018. The disclosure of the above application is incorporated herein by reference.

### FIELD

The present disclosure relates to well head caps used at landfill wells, and more particularly to a well head cap having stabilization features for assisting in longitudinally supporting a discharge tube extending from a well bore out through the well head cap, to help maintain the discharge tube in a vertical orientation.

### BACKGROUND

The statements in this section merely provide background information related to the present disclosure and may not constitute prior art.

Known well head covers used in landfill and similar gas production wells have an exhaust sleeve through which a methane gas discharge pipe is led. The methane gas discharge pipe is typically the single largest service pipe or tube connected to the well head. Where multiple service ports are required, they are typically added downstream of the well head covers, or are tapped into the covers at different locations. However, the well head cover is generally not designed to provide direct support for the weight of all the various components that may end up being connected to the well head cover.

Known drawbacks with existing well head covers include bending/deflection problems due to the provision of only a single discharge pipe support member that vertically supports the discharge pipe. With only a single sleeve or support flange, the weight and moment of the methane gas discharge pipe and its associated valves and components can cause the components at the weld head to bend or sag. This can result in cracking and/or gas leakage of the discharge pipe or associated components, and/or disorientation of components such as an orifice plate assembly used for flow rate determination, which can lead to inaccurate flow measurements.

Accordingly, there is a need for a well head cover which is better able to support the external forces applied to a discharge tube extending through the well head cover, to better maintain the discharge tube in a vertically upright orientation, regardless of the collective weight of the external components connected to, or acting on, the discharge tube.

### SUMMARY

This section provides a general summary of the disclosure, and is not a comprehensive disclosure of its full scope or all of its features.

In one aspect the present disclosure relates to a well head cover for mounting on a landfill gas discharge pipe. The well head cover comprises a polymer molded body, with the body having a neck with an outlet orifice surface sized to accommodate the landfill gas discharge pipe extending through the outlet orifice surface. A stabilizer is disposed within the body that stabilizes the polymer molded body to the landfill gas discharge pipe, and assists in maintaining the landfill gas discharge pipe in a vertically upright orientation.

In another aspect the present disclosure relates to a well head cover for mounting on a landfill gas discharge pipe. The well head cover comprises a polymer molded body, with the body having a round neck with an outlet orifice surface sized to accommodate the landfill gas discharge pipe extending through the outlet orifice surface. A stabilizer is disposed within the body that stabilizes the polymer molded body to the landfill gas discharge pipe, and assists in maintaining the landfill gas discharge pipe in a vertically upright orientation against external forces acting on the landfill gas discharge pipe. The stabilizer includes a flanged insert having a sleeve and a flange. The sleeve is dimensioned to fit within the outlet orifice surface and to extend along at least a portion of a length of the neck. The sleeve provides additional areas of contact with the landfill gas discharge pipe to help maintain the landfill gas discharge pipe in a vertically upright orientation.

In still another aspect the present disclosure relates to a well head cover for mounting on a landfill gas discharge pipe. The well head cover comprises a polymer molded body, with the body having a round neck with an outlet orifice surface sized to accommodate the landfill gas discharge pipe extending through the outlet orifice surface. The neck is arranged eccentrically relative to an axial center of the body. A flanged insert is disposed within the neck and coaxial with an axial center of the neck. The flanged insert stabilizes the landfill gas discharge pipe and assists in maintaining the landfill gas discharge pipe in a vertically upright orientation against external forces acting on the landfill gas discharge pipe. The flanged insert has a sleeve and a flange extending perpendicularly from the sleeve. The flange is dimensioned to rest on an upper surface of the neck, and the sleeve is dimensioned to fit within the outlet orifice surface and to extend along at least a major portion of a length of the neck. The sleeve provides a plurality of additional, longitudinally spaced apart areas of contact with the landfill gas discharge pipe to help maintain the landfill gas discharge pipe in a vertically upright orientation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a partial cross sectional side view of a landfill well assembly and associated equipment located at a landfill well, and also showing a well head cover of the present disclosure with various components that are typically coupled to the well head cover;

FIG. 2 is an enlarged view of the well head cover shown in FIG. 1 with the various components with which it is often used;

FIG. 3 is a side cross sectional view of the well head cover of FIG. 2 and also illustrating a portion of the well discharge pipe extension extending longitudinally through an axial center of the well head cover;

FIG. 4 is a perspective side/top view of a well head cover in accordance with another embodiment of the present disclosure, which incorporates a plurality of bumpers formed to project from an internal wall portion of a neck of the well head cover to help maintain the discharge pipe extension axially aligned, and in a generally vertical orientation, with a longitudinal axis of the well head cover;

FIG. 5 is a side cross sectional view of the well head cover taken in connection with section line 5-5 in FIG. 4;

FIG. 6 is a side/top perspective view of a well head cover in accordance with another embodiment of the present disclosure;

FIG. 7 is a cross sectional view of the well head cover taken in accordance with section line 7-7 in FIG. 6;

FIG. 8 is a three dimensional perspective illustration of another embodiment of the well head cover of the present disclosure which makes use of a plurality of spring loaded, circumferentially arranged fingers for helping to keep the discharge pipe extension longitudinally centered within a neck of the well head cover, and where a portion of the external structure of the well head cover is shown transparently to avoid obscuring the internal structure of the well head cover;

FIG. 9 is a side cross sectional view of the well head cover of FIG. 8 taken in accordance with section line 9-9 in FIG. 8;

FIG. 10 is a side cross sectional view of another embodiment of the well head cover of the present disclosure which incorporates an internal sleeve for increasing a longitudinal contact surface area with the discharge pipe extension, to help support the discharge pipe extension in a vertically configured fashion within the well head cover;

FIG. 11 is a perspective view of the well head cover of FIG. 10 which also reveals the flange formed at an upper end of the sleeve, and with certain structure of the well head cover shown transparently to avoid obscuring internal structure of the well head cover;

FIG. 12 shows a side cross sectional view of the well head cover of FIG. 10 coupled between a reducer and a boot fitting, which further illustrates the alignment of the internal sleeve along an axial centerline of the neck of the well head cover, and also being coaxial with the axial centers of the reducer and the boot fitting; and

FIG. 13 is an exploded perspective illustration of the well head cover, the sleeve, the reducer and the boot fitting, previously shown assembled together in FIG. 12.

### DETAILED DESCRIPTION

Example embodiments will now be described more fully with reference to the accompanying drawings.

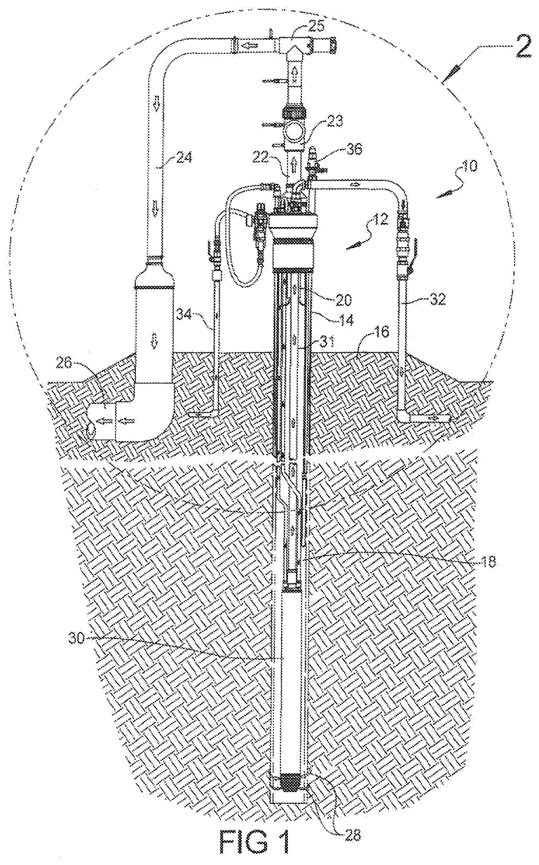

Referring to FIG. 1, a landfill well system 10 includes a well head assembly 12 which is mounted to a plastic well pipe 14, which is typically a six inch or eight inch diameter pipe. Well pipe 14 extends approximately three to four feet above a ground level of a multiple layer landfill gradient 16. Well pipe 14 includes multiple holes 18 in a zone approximately extending thirty to over one hundred feet below the well surface that permit influx of methane gas into the well pipe 14. Methane gas rises into a well discharge pipe 20 that includes an above ground discharge pipe extension 22. The above ground discharge pipe extension 22 may be the same tube as the well discharge pipe 20, or may be a separate tube that is connected to the well discharge pipe 20, but in either case gas travels upwards through the well discharge pipe 20 and then through the above ground discharge pipe extension 22. If not the same tube, then the above ground discharge pipe extension 22 may abut and/or be coaxial with the well discharge pipe 20. The methane gas passes through multiple components including an orifice plate assembly 23 used to measure gas flow rate, and a control valve 25 used to meter gas flow rates, and is transferred via a flow pipe 24 to a larger collection pipe 26. Well head assembly 12 provides for, and landfill well system 10 can further include, a plurality of influent apertures 28 near the bottom end of well pipe 14 that allow liquid known as “leachate” to collect at the well pipe foot. Before reaching holes 18, the leachate is discharged using a pump 30 via an in-well fluid discharge pipe 31 and an external well fluid discharge pipe 32. Other services provided by well head assembly 12 include an air inlet line 34 and a well fluid level detector 36.

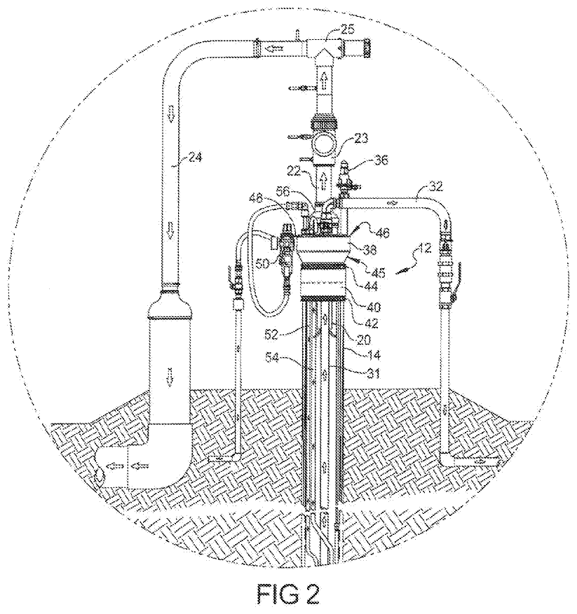

Referring to FIG. 2 and again to FIG. 1, well head assembly 12 includes a well head cover 38 of the present disclosure which rests on an upper end face of well pipe 14. The well head cover 38 can be formed as a single polymer piece. The well head cover 38 can be formed by rotational molding. Alternatively, the well head cover 38 can be formed by injection molding. Well head cover 38 is retained in place using a commonly known flexible rubber boot fitting 40 using a first band strap 42 at the well pipe 14 and a second band strap 44 at the connection to well head cover 38. Well head cover 38 is therefore removable if desired by releasing first and second band straps 42,44 and releasing well head cover 38 from boot fitting 40. In addition to directly supporting well discharge pipe 20 including (if incorporated) its integrally connected discharge pipe extension 22, a polymeric body 45 of well head cover 38 includes an integrally connected cover service plate 46. Cover service plate 46 includes service ports for multiple services such as a bracket 48 retaining a filter/regulator 50 of an air supply system, a tube supporting well fluid level detector 36, and a connector for external well fluid discharge pipe 32. A supply air line 52 and an air discharge line 54 are also connected to cover service plate 46. It is also noted a reducer 56, such as a flexible rubber reducer, can be connected at the discharge location of discharge pipe extension 22 to suit the diameter of the discharge pipe extension 22.

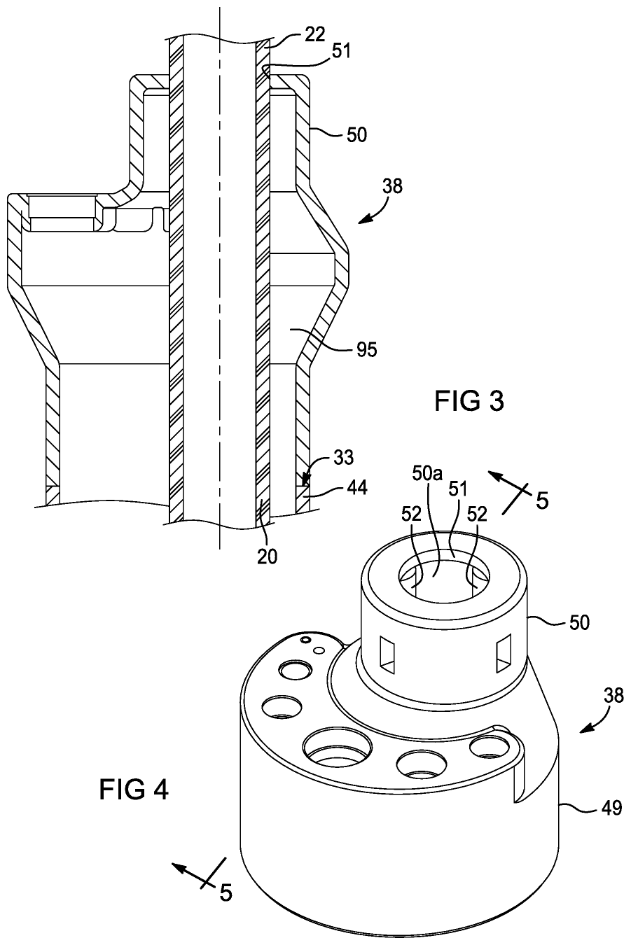

FIG. 3 shows the well head cover 38 mounted around a portion of the well discharge pipe extension 22 (which may alternatively be the well discharge pipe 20). For the remaining discussion of the well head cover 38, any reference to the well discharge pipe 20 can refer to the extension pipe 22 as well, being that these portions can be part of the same tube or otherwise mechanically attached end-to-end.

Due to wind and other environmental forces, as well as forces introduced by operation and/or servicing of the landfill well system 10, the well discharge pipe 20 can move (e.g., in a rocking manner) relative to the well pipe 14. Such movement risks loosening of fittings and unintended escape of gases. Various features are disclosed herein for preventing this movement by stabilizing the well head cover 38 relative to the well discharge pipe 20.

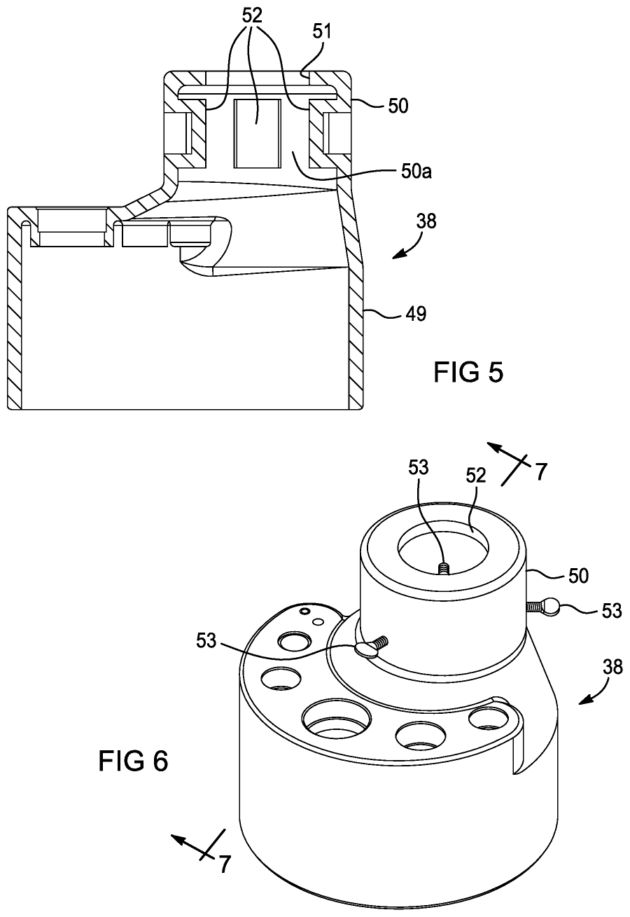

FIGS. 4-5 show a well head cover 38 having stabilizing bumpers in accordance with one embodiment of the present disclosure. FIG. 4 shows an isometric view of the well head cover 38 while FIG. 5 shows a cross-sectional view taken along section line 5-5 in FIG. 4. The well head cover 38 includes a neck 50 which extends upward from a main body 49. The neck 50 fits over the well discharge pipe 20 and provides a stabilization fit. An annular orifice surface 51 fits around the discharge pipe 20 by having an inner diameter that is only slightly larger than, or the same as, the outer diameter of the discharge pipe 20. The annular orifice surface 51, being a near fit on the discharge pipe 20, helps to stabilize the well head cover 38 about the discharge pipe 20. However, a conventional well head cover provides only one area of stabilization vertically along the discharge pipe 20, and can therefore permit rocking of the discharge pipe 20. Therefore, the well head cover 38 of the present disclosure advantageously includes bumpers 52 which are provided further longitudinally down the neck 50. The bumpers 52 are arrayed about the inner circumference of the neck 50 and project inward to engage and stabilize the discharge pip 20. The bumpers 52 are formed by the body material of the well head cover 38. In this way, the bumpers 52 are molded together with the neck 50 and the rest of the well head cover 38. In alternative embodiments, the bumpers 52 can be separately formed and then screwed, bolted, adhered, heat bonded, or otherwise attached to an inner wall 50a of the neck 50.

The bumpers 52 project inwardly from the neck 50 to contact the outer surface of the discharge pipe 20. As shown in FIG. 5, the bumpers 52 are spaced apart from the annular orifice surface 51 to further stabilize the well head cover 38 about the discharge pipe 20. The bumpers 52 are made to fit to the outer diameter of the discharge pipe 20. Four bumpers 52 are shown, each at 90 apart, evenly arrayed about the neck 50. Alternatively a greater or lesser number of bumpers 52 can be used. It is noted that the bumpers 52 are rounded which are easier to form and less likely to catch or jam during insertion of the discharge pipe 20.

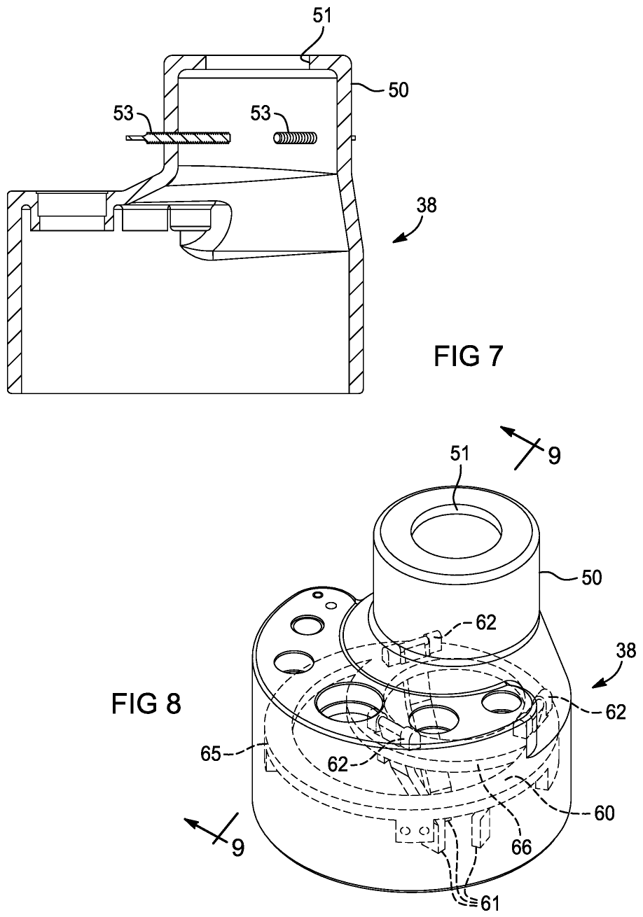

FIGS. 6-7 show an alternative well head cover 38 in accordance with the present disclosure. The well head cover 38 illustrated in FIGS. 67 includes a plurality of screws 53 extending into the neck 50. The screws 53 thread through the wall of the neck 50 to engage the exterior of the discharge pipe 20. The screws 53 can be stainless steel having a threaded exterior which is complementary to a threaded interior of apertures through the neck 50. By rotation, the screws 53 can be moved in and out to different degrees to account for any pitched angle of the discharge pipe 20 relative to the well head cover 38 (and well pipe 14), as well as center the discharge pipe 20 within the neck 50. As with the earlier embodiment shown in FIG. 4, the annular orifice surface 51 of the embodiment of FIGS. 6-7 forms one area of engagement along the discharge pipe 20, while the screws 53 form a different area of engagement down the discharge pipe 20 relative to the annular orifice surface 51. The screws 53 can be hand adjusted. While three evenly arrayed screws 53 are shown, a greater number can instead be used, such as four.

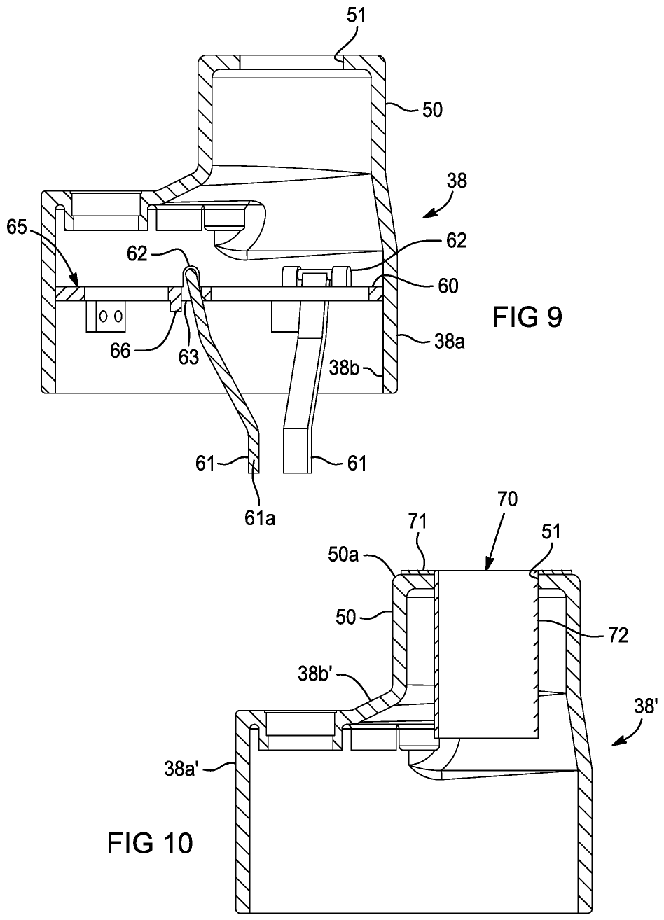

FIGS. 8-9 show another alternative embodiment of the well head cover 38 which incorporates a spring loaded adapter 65. FIG. 8 is a three-dimensional perspective view while FIG. 9 is a cross-sectional view. The adaptor 65 is fit inside a bottom portion of the well head cover 38. A bottom portion 38a of the well head cover 38 inside which the adapter 65 is fit is round and forms an inner cylindrical section 38b (FIG. 9). The adapter 65 includes a support ring 30 which can be screwed, bolted, adhered, or otherwise connected to the inner surface of the wall defining the inner cylindrical section 38b of the well head cover 38.

The adapter 65 includes an inner ring 66 which is entirely within the outer support ring 60 but arranged eccentrically to the outer support ring. The inner ring 66 is attached to the outer support ring 60. The inner ring 66 is located to be coaxial with the annular orifice surface 51, and also coaxial with the discharge pipe 20 that extends through the inner ring 66. Hinges 62 are mounted on the inner ring 66. Attached to the hinges 62 are fingers 61. The fingers 61 each hinge from a respective one of the hinges 62 to move closer to, or away from, the center of the discharge pipe 20 coaxial with the inner ring 66. The fingers 61 are each spring-loaded by a respective spring 63 to bias the fingers 61 to project inwardly toward an axial center of the inner ring 66. The fingers 61 contact the outer surface of the discharge pipe 20 to center and stabilize the discharge pipe within the inner ring 66 and within the neck 50 of the well head cover 38. The fingers 61 can help hold the discharge pipe 20 coaxially centered with the annular orifice surface 51. The annular orifice surface 51 can represent a top interference point while a lower portion 61a of each of the fingers 61, as shown in FIG. 9, can present a lower interference point to stabilize the discharge pipe 20 relative to the well head cover 38. Three fingers 61 are shown, however a greater number can be used. The fingers 61 are arrayed evenly about the inner ring 66. Advantageously, the spring action of each of the fingers 61 allow the fingers to adapt to different diameter sizes of the discharge pipe 20.

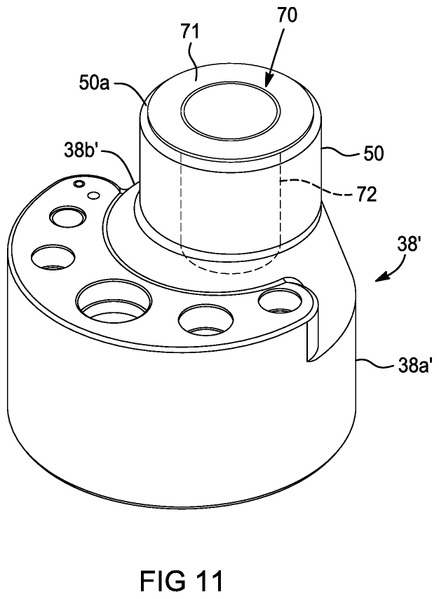

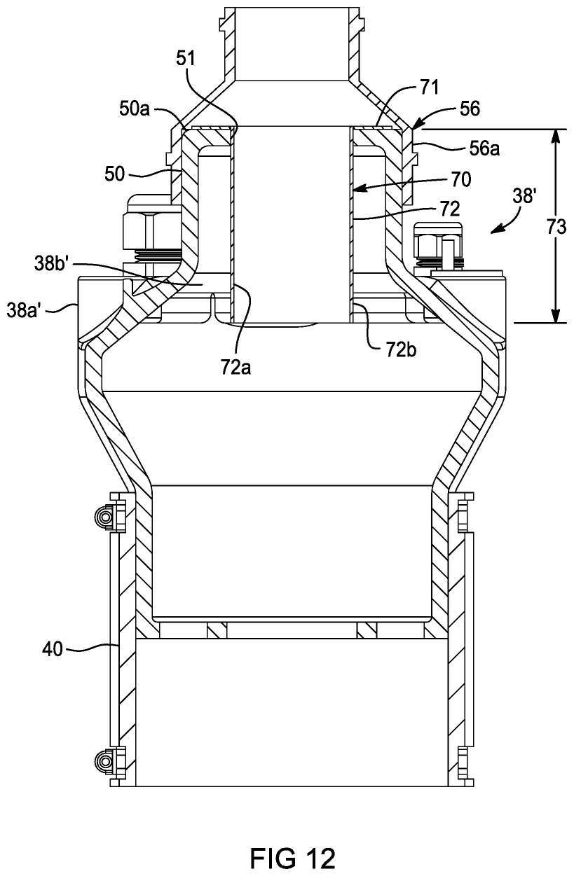

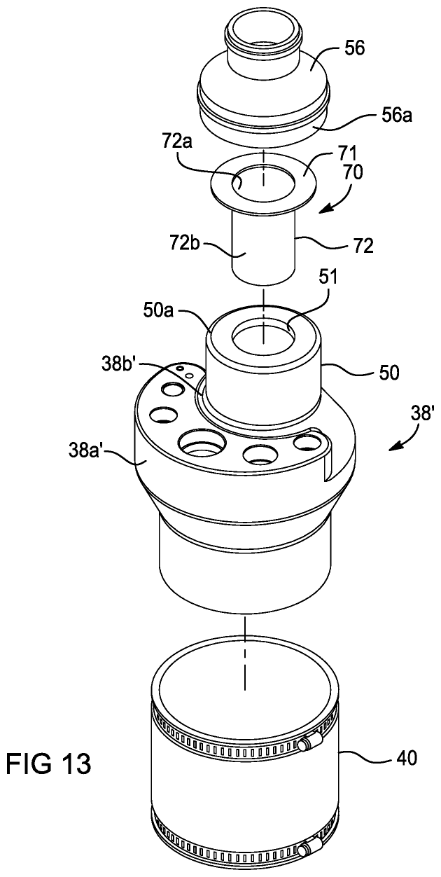

FIGS. 10-13 show an alternative well head cover 38′ design having a body portion 38a′ and a tapering transition portion 38b′, which are integrally formed with one another and with the neck 50. The neck 50 includes a flanged insert 70 integrally formed therewith. FIG. 10 is a cross sectional view, FIG. 11 is a three-dimensional perspective view, FIG. 12 is another cross-sectional view, and FIG. 13 is an exploded perspective view of the individual components shown in the assembled illustrations of FIGS. 10, 11 and 12. The flanged insert 70 includes a sleeve 72 and a flange 71. The flange 71 is located at a top end of the sleeve 72 and in this example extends generally perpendicularly from the sleeve 72. The sleeve 72 is tubular, with a cylindrical inner surface 72a and a cylindrical outer surface 72b. The outer diameter of the sleeve 72 is the same as, or dose to, or slightly smaller than, the inner diameter of the annular orifice surface 51 at the top end of the neck 50. The flange 71 sits on a top surface 50a of the neck 50. As shown, the flange 71 can be flat and fits flush with the flat top surface 50a of the neck 50. In this way, both the bottom surface of the flange 71 and the top surface 50a of the well head cover 38′ can be planar surfaces that are parallel with each other such that the flange 71 circumferentially engages the top surface 50a about the annular orifice surface 51. The outer cylindrical surface of the sleeve 72 can annularly interface with the inward facing annular orifice surface 51 to stabilize the flanged insert 70 within the well head cover 38′ and align the sleeve 72 with the bore of the neck 50. Such engagement discussed above can align the bore of the sleeve 72 with the bore of the well head cover 38′ for aligning the discharge pipe 20 and the well head cover 38′.

As shown in FIGS. 10-12, the flange 71 covers a substantial majority of the top surface 50a of the neck 50, but without interfering with placement of a lower wall portion 56a of the reducer 56 over the neck 50. The flanged insert 70, including both the sleeve 72 and the flange 71, are coaxial with the annular orifice surface 51 and the discharge pipe 20. In this example, the thickness of the sleeve 72 and the flange 71 are approximately equal, which further helps maintain the simplicity of manufacture of the flanged insert 70.

Advantageously, the flange 71 is wider than the annular orifice surface 51 which seats the flanged insert 70 in the neck 50 and prevents the flanged insert 70 from slipping further into the interior of the well head cover 38′. The outer diameter of the discharge pipe 20 can be the same as or slightly smaller than the inner diameter of the sleeve 72 of the flanged insert 70. The inner cylindrical surface of the sleeve 72 of the flanged insert 70 extends along the outer surface cylindrical surface of the discharge pipe 20 for a distance of several inches (e.g., two-twelve inches or more). As shown in FIG. 10, the sleeve 72 in this embodiment has a length which extends fully through the neck 50. As such, the interference between the outer surface of the discharge pipe 20 and the inner surface 72a of the sleeve 72 of the flanged insert 70 allows for a significantly extended length of contact at different vertically spaced points, and without requiring the outer diameter of the discharge pipe 20 to be appreciably reduced. Such vertically distributed interference inhibits movement (particularly rocking movement) of the discharge pipe 20 relative to the flanged insert 70 and well head cover 38′ to stabilize the discharge pipe 20.

From FIG. 12 in particular, it will be noted that the length of surface area contact provided by the sleeve 72, as indicated by dimensional arrow 73 in FIG. 12, is several times that provided by just the longitudinal thickness of the annular orifice surface 51. This additional longitudinal surface area for helps to maintain the discharge pipe 20 in a vertical upright position. The fact that the sleeve 72 forms a full 360 degree sleeve, helps to maintain the discharge pipe 20 in a stable (e.g., typically vertical) orientation regardless of the direction of the forces which are acting on the discharge pipe 20. Thus, there is minimal or no need for any adjustments to the well head cover 38′ or the flanged insert 70, at the time of installation of the well head cover 38′, to account for the specific direction of the radial or torsional forces that are acting on the discharge pipe 20.

The flanged insert 70 can be formed from metal (e.g., stainless steel) or polymer. Accordingly, the flanged insert 70 forms a strong and highly rigid component that further helps to enhance the structural rigidity of the neck 50. The flanged insert 70 is a discrete part, including both the flange 71 and the sleeve 72, which is separate from the well head cover 38 but which slides axially into the bore of the well head cover 38′ to interface with the well head cover 38′.

The present disclosure is made using several embodiments and examples to highlight various inventive aspects. Modifications can be made to the embodiment presented herein without departing from the scope of the invention. As such, the scope of the invention is not limited to the embodiment disclosed herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below.

The device may be otherwise oriented (rotated 90 degrees or at other orientations) and the spatially relative descriptors used herein interpreted accordingly.

What is claimed is:

1. A well head cover for mounting on a landfill gas discharge pipe, the well head cover comprising:
a polymer molded body, the body having a neck with an outlet orifice surface sized to accommodate the landfill gas discharge pipe extending through the outlet orifice surface, and
a stabilizer disposed within the body that stabilizes the polymer molded body to the landfill gas discharge pipe, and assists in maintaining the landfill gas discharge pipe in a vertically upright orientation.

2. The well head cover of claim 1, wherein the stabilizer comprises multiple, circumferentially spaced apart projections that project from within the neck to interface with the landfill gas discharge pipe at a plurality of locations on the landfill gas discharge pipe.

3. The well head cover of claim 1, wherein the stabilizer comprises multiple screws arranged circumferentially around the neck, that thread through a wall of the neck and project inward within the polymer molded body, to interface with the landfill gas discharge pipe at multiple points around a circumference of the landfill gas discharge pipe.

4. The well head cover of claim 1, wherein the stabilizer comprises multiple spring loaded fingers spaced circumferentially within the neck, that project inward within the polymer molded body to interface with the landfill gas discharge pipe at multiple points around a circumference of the landfill gas discharge pipe.

5. The well head cover of claim 1, wherein the stabilizer comprises a flanged insert comprising a sleeve and a flange, the flanged insert sized to fit around the landfill gas discharge pipe while the flanged insert seats in the outlet orifice surface.

6. The well head cover of claim 5, wherein the sleeve of the flanged insert comprises a length which extends along a major portion of a length of the neck of the well head cover.

7. The well head cover of claim 5, wherein the sleeve of the flanged insert comprises a length which extends beyond a full length of the neck of the well head cover.

8. The well head cover of claim 5, wherein the sleeve of the flanged insert is arranged coaxial with the outlet orifice surface and coaxial with the landfill gas discharge pipe.

9. The well head cover of claim 8, wherein the sleeve of the flanged insert and the neck are arranged coaxial with one another, but eccentrically with the body of the well head cover.

10. The well head cover of claim 5, wherein the flanged insert is formed from at least one of metal or a polymer material.

11. A well head cover for mounting on a landfill gas discharge pipe, the well head cover comprising:
a polymer molded body, the body having a round neck with an outlet orifice surface sized to accommodate the landfill gas discharge pipe extending through the outlet orifice surface;
a stabilizer disposed within the body that stabilizes the polymer molded body to the landfill gas discharge pipe, and assists in maintaining the landfill gas discharge pipe in a vertically upright orientation against external forces acting on the landfill gas discharge pipe; and
the stabilizer including a flanged insert having a sleeve and a flange, the sleeve being dimensioned to fit within the outlet orifice surface and to extend along at least a portion of a length of the neck, the sleeve providing additional areas of contact with the landfill gas discharge pipe to help maintain the landfill gas discharge pipe in a vertically upright orientation.

12. The well head cover of claim 11, wherein the sleeve of the flanged insert extends a full length of the neck.

13. The well head cover of claim 12, wherein the sleeve extends a length greater than the full length of the neck.

14. The well head cover of claim 11, wherein the flange of the flanged insert rests on an upper surface of the neck and is dimensioned to be larger than a diameter of the outlet orifice surface.

15. The well head cover of claim 11, wherein the flanged insert is arranged coaxial with the outlet orifice surface, and the flanged insert and the outlet orifice surface are arranged eccentrically with the body of the well head cover.

16. The well head cover of claim 11, wherein the flanged insert is formed from at least one of metal or a polymer material.

17. A well head cover for mounting on a landfill gas discharge pipe, the well head cover comprising:
a polymer molded body, the body having a round neck with an outlet orifice surface sized to accommodate the landfill gas discharge pipe extending through the outlet orifice surface, the neck being arranged eccentrically relative to an axial center of the body;
a flanged insert disposed within the neck and coaxial with an axial center of the neck, that stabilizes the landfill gas discharge pipe and assists in maintaining the landfill gas discharge pipe in a vertically upright orientation against external forces acting on the landfill gas discharge pipe; and
the flanged insert having a sleeve and a flange extending perpendicularly from the sleeve, the flange dimensioned to rest on an upper surface of the neck, and the sleeve being dimensioned to fit within the outlet orifice surface and to extend along at least a major portion of a length of the neck, the sleeve providing a plurality of additional, longitudinally spaced apart areas of contact with the landfill gas discharge pipe to help maintain the landfill gas discharge pipe in a vertically upright orientation.

18. The well head cover of claim 17, wherein the sleeve has a length which extends along a full length of the neck.

19. The well head cover of claim 17, wherein the sleeve has a length which is greater than a length of the neck.

20. The well head cover of claim 17, wherein the flanged insert is formed from at least one of metal or a polymer material.
